(19) United States
(12) Patent Application Publication
(10) Pub. No.: US 2007/0214888 A1
(43) Pub. Date: Sep. 20, 2007

(54) Acceleration sensor with protrusions facing stoppers

(75) Inventor: Akihiko Nomura, Miyazaki (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD.

(21) Appl. No.: 11/705,763

(22) Filed: Feb. 14, 2007

(30) Foreign Application Priority Data
Mar. 14, 2006 (JP) 2006-069654

(51) Int. Cl. G01P 15/00

(52) U.S. Cl. 73/514.01

(57) ABSTRACT

An integrally micromachined acceleration sensor has a mass with a surface facing a stopper. At least one protrusion projects from this surface toward the stopper. In the absence of acceleration, the protrusion is spaced apart from the stopper, but by limiting motion of the mass toward the stopper, the protrusion improves the shock resistance of the acceleration sensor. The protrusion also prevents the mass from sticking to the stopper during the fabrication process. The stopper may have a pattern of holes surrounding the protrusion, so that the protrusion is produced naturally during the wet etching process that separates the mass from the stopper. The holes also shorten the wet etching time.

### BACKGROUND OF THE INVENTION

1. Field of the Invention

The present invention relates to a micromachined acceleration sensor, more particularly to an acceleration sensor with features that aid the micromachining process and improve the robustness of the sensor.

2. Description of the Related Art

Known micromachined acceleration sensors include three-axis acceleration sensors having a mass flexibly linked to a frame by beams with microelectronic strain detectors. Acceleration sensors of this type can be classified into a bonded type, which is formed by micromachining different layers of the sensor on separate substrates and then bonding the layers together, and an integral type, which is formed by micromachining a substrate that already has a layered structure. The present invention relates to a three-axis acceleration sensor of the integral type, such as the one described in Japanese Patent Application Publication (JP) No. 2004-198243.

The frame of this type of acceleration sensor includes stoppers that limit the motion of the mass. Because the sensor is of the integral type, the micromachining process includes a wet etching step that separates the stoppers from the mass, followed by a cleaning step that rinses the etching solution out from the space between the mass and the stoppers. The dimensions of the acceleration sensors now being produced have become so small that after the cleaning process, the mass and stoppers may still be joined by drops of rinsing solution. This leads to a fabrication problem, because as the remaining rinsing solution dries, its surface tension draws the mass toward the stoppers and may cause the mass and stoppers to stick together.

JP 2004-294401 (U.S. Patent Application Publication No. 20040187592) discloses a single-axis capacitive acceleration sensor in which the bottom surfaces of the mass and moving electrodes are etched laterally in such a way as to leave protrusions to prevent the bottom surfaces from sticking to the base layer of the substrate, but the formation of these protrusions requires laterally convex extensions of the mass and electrodes. Similar protrusions between the mass and stoppers of a three-axis acceleration sensor could be considered, but in a three-axis sensor the necessary laterally convex extensions would undesirably limit the freedom of motion of the mass. If the lateral dimensions of the mass were to be reduced to regain the necessary freedom of motion, the resulting loss of inertial mass would reduce the sensitivity of the sensor, which would also be undesirable.

### SUMMARY OF THE INVENTION

An object of the present invention is to prevent the mass of an acceleration sensor from sticking to the stoppers during the fabrication process.

Another object of the invention is to shorten the fabrication process.

Still another object is to increase the robustness of the acceleration sensor.

Yet another object is to increase the sensitivity of the acceleration sensor.

The invented acceleration sensor has a patterned layer including a mass attachment section, a peripheral attachment section, at least one beam flexibly linking the mass attachment section to the peripheral attachment section, and at least one stopper contiguously joined to the peripheral attachment section. A mass having a surface facing the stopper is joined to the mass attachment section by a first joining layer. A frame surrounding the mass is joined to the peripheral attachment section by a second joining layer.

The surface of the mass that faces the stopper has at least one protrusion that protrudes toward the stopper. Absent acceleration, the protrusion is spaced apart from the stopper. Preferably, there are a plurality of such protrusions, which may be arranged in a two-dimensional array extending over substantially the entire surface of the mass that faces the stopper. The protrusions are preferably made of the same material as the first and second joining layers.

The stopper preferably has a plurality of holes positioned such that each protrusion is disposed between geometric projections of at least two of the holes onto the surface of the mass.

The invented acceleration sensor may be fabricated by a method including the steps of:

preparing a substrate having a first layer, a second layer, and a joining layer through which the first layer is joined to the second layer;

patterning the first layer to form a mass attachment section, a peripheral attachment section surrounding and spaced apart from the mass attachment section, at least one beam flexibly linking the mass attachment section to the peripheral attachment section, and at least one stopper contiguously joined to the peripheral attachment section and spaced apart from the mass attachment section and the beam;

patterning the second layer to form a mass spaced apart from the stopper, having a surface facing the stopper, and a frame surrounding and spaced apart from the mass; and

selectively removing the joining layer to leave a first joining layer joining the mass to the mass attachment section, a second joining layer joining the frame to the peripheral attachment section, and at least one protrusion protruding from said surface of the mass toward the stopper, the protrusion being spaced away from the stopper.

The step of selectively removing the joining layer is preferably carried out by wet etching.

The step of patterning the first layer preferably also forms a plurality of holes facing respective areas on said surface of the mass, each protrusion being disposed between at least two of these areas.

The protrusions prevent the mass from sticking to the stopper during the fabrication process.

The holes formed in the stopper shorten the fabrication process by facilitating the etching of joining-layer material between the mass and stopper and naturally leading to the formation of the protrusions.

The protrusions increase the robustness of the acceleration sensor by shortening the distance through which the mass can travel toward the stopper, thereby reducing the risk of beam or stopper damage caused by shock.

By slightly increasing the amount of mass, the protrusions increase the sensitivity of the sensor.

### BRIEF DESCRIPTION OF THE DRAWINGS

In the attached drawings:

FIG. 1 is a perspective view of an acceleration sensor embodying the present invention;

FIG. 2 is an upper plan view of the acceleration sensor in FIG. 1;

FIG. 3 is a sectional view through line AA′ in FIG. 1;

FIG. 4 is a sectional view through line BB′ in FIG. 1;

FIG. 5 is a partial perspective view of the mass in FIG. 1;

FIG. 6 is an upper plan view of the first layer in FIG. 1;

FIG. 7 is an upper plan view of the joining layer in FIG. 1;

FIG. 8 is an upper plan view of the second layer in FIG. 1;

FIGS. 9, 10, 11, 12, and 13 are sectional views illustrating steps in the fabrication of the acceleration sensor in FIG. 1;

FIGS. 14, 15, 16, and 17 are plan views illustrating possible layouts of the holes and protrusions in FIG. 1;

FIG. 18 is a perspective view of a conventional acceleration sensor;

FIG. 19 is an upper plan view of the conventional acceleration sensor;

FIG. 20 is a sectional view illustrating a starting state in the fabrication of the conventional acceleration sensor;

FIGS. 21A, 22A, and 23A are sectional views through line AA′ in FIG. 18, illustrating successive steps in the conventional fabrication process;

FIGS. 21B, 22B, and 23B are corresponding sectional views through line BB′ in FIG. 18; and

FIGS. 21C, 22C, and 23C are corresponding upper plan views of various layers in FIG. 18.

### DETAILED DESCRIPTION OF THE INVENTION

Embodiments of the invention will now be described with reference to the attached drawings, in which like elements are indicated by like reference characters.

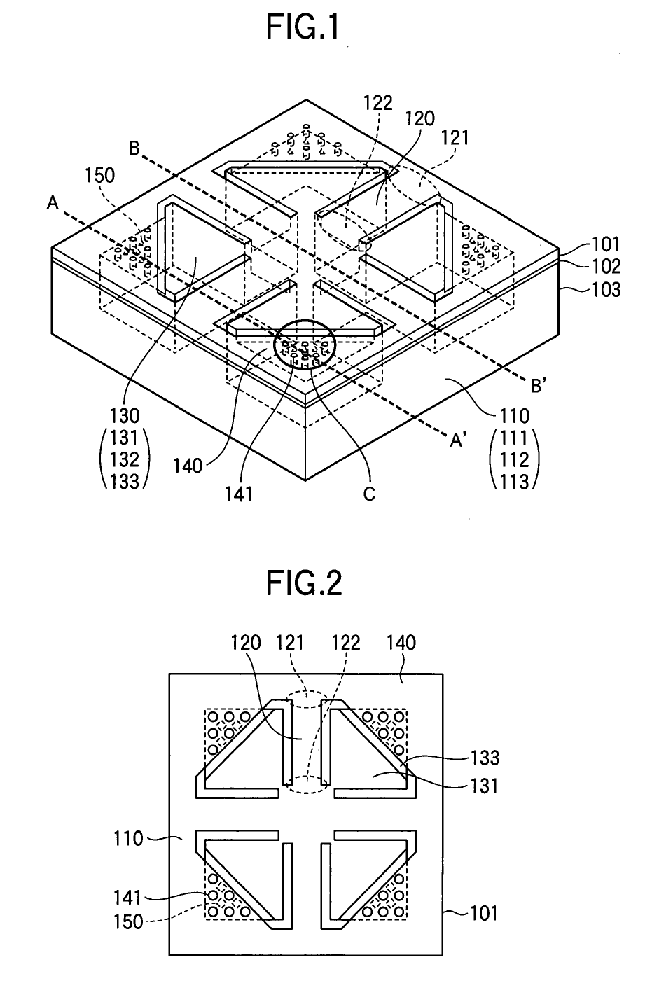

A three-axis acceleration sensor embodying the present invention is shown in perspective view in FIG. 1. The acceleration sensor is fabricated in a substantially square substrate having a first layer or patterned layer 101 joined by a joining layer 102 to a second layer 103. The peripheral section 110 of the acceleration sensor includes a peripheral attachment section 111 formed in the first layer 101, joined through the joining layer 102 to a frame 113 formed in the second layer 103. Four beams 120 extend in the first layer 101 from the peripheral attachment section 111 toward the central section 130 of the acceleration sensor. The central section 130 includes a mass attachment section 131 formed in the first layer 101, joined through the joining layer 102 to a mass 133 formed in the second layer 103. Each beam 120 is integrally attached at a first end 121 to the peripheral attachment section 111 and a second end 122 to the mass attachment section 131, and includes piezoresistive elements (not shown) for sensing strain when the beam 120 bends.

The part of the joining layer 102 that joins the mass attachment section 131 to the mass 133 will be referred to as the first joining layer 132; the part of the joining layer 102 that joins the peripheral attachment section 111 to the frame 113 will be referred to as the second joining layer 112.

Four stoppers 140 are disposed in the first layer 101 at the four inner corners of the peripheral attachment section 111, to which they are connected. Each stopper 140 has the shape of a right isosceles triangle. A plurality of holes 141 are formed in each stopper 140, extending from its top surface to its bottom surface.

The mass 133 has for square lobes, each with a surface that extends partly beneath one of the stoppers 140. A plurality of protrusions 150 extend from this surface toward the facing undersurface of the stopper 140. As shown by the top plan view in FIG. 2, the protrusions 150 project toward points disposed between the holes 141 in the stopper 140.

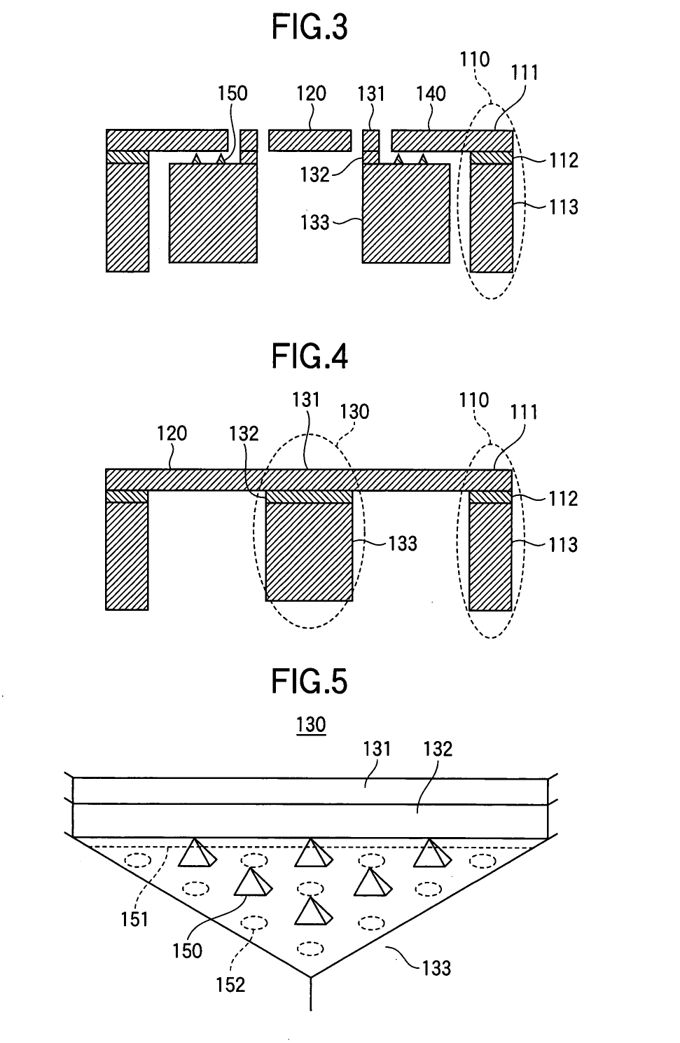

The mass attachment section 131 is spaced apart from the sides of the beams 120, and from the stoppers 140. The four lobes of the mass 133 are spaced apart from the frame 113, and absent acceleration, the protrusions 150 are spaced apart from the stoppers 140, as shown in FIG. 3. The central part of the mass 133 is widely spaced apart from the frame 113 by cavities below the beams 120, as shown in FIG. 4.

The protrusions 150 have a square pyramidal shape, as best seen in FIG. 5. This drawing shows part of one lobe of the mass 133. The facing stopper 140 is omitted from FIG. 5 for clarity, but the part of the surface of the mass 133 that faces the stopper 140 is bounded by the dotted line 151. Circular dotted lines in FIG. 5 define areas 152 facing the holes 141 in the stopper 140. The protrusions 150 are disposed between these areas 152, which are geometric projections of the holes, and the protrusions 150 are oriented so that their sides face toward these areas 152.

The greater the height of the protrusions 150, the less the mass 133 can move toward the stoppers 140. The height of the protrusions 150 should be chosen to allow enough motion for acceleration to be sensed but not so much motion that the beams 120 might break under strong acceleration.

Most of the part of the square lobe of the mass 133 that does not face the stopper 140 is joined by the first joining layer 132 to the mass attachment section 131, as shown at the back of FIG. 5. The space between the dotted line in FIG. 5 and the first joining layer 132 corresponds to the space between the mass attachment section 131 and stopper 140 in FIGS. 1 and 2.

Although the substrate layers 101, 102, and 103 are unitarily contiguous and cannot be separated from one another, strictly for explanatory purposes, FIGS. 6, 7, and 8 show top plan views of the three layers separately.

The first layer 101, shown in FIG. 6, is a silicon layer with a preferred thickness in the range from three to eight micrometers (3-8 μm). The mass attachment section 131 is separated from the beams 120 and stoppers 140 by trenches 401 with a preferred width of 10-25 μm.

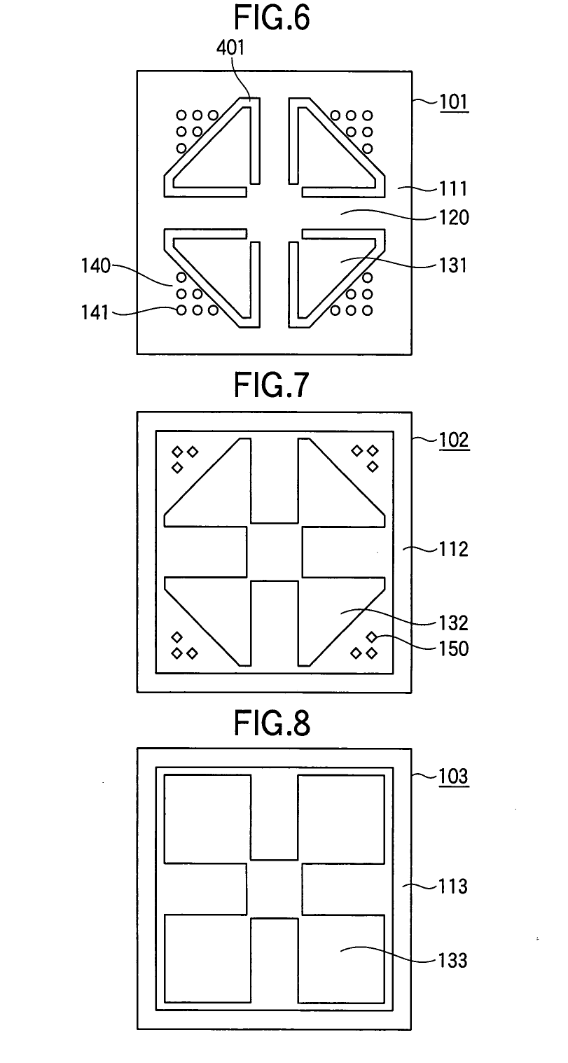

The joining layer 102, shown in FIG. 7, is a silicon oxide layer with a preferred thickness of 1-3 μm. The joining layer 102 includes not only the second joining layer 112 that joins the peripheral attachment section 111 to the frame 113 and the first joining layer 132 that joins the mass attachment section 131 to the mass 133, but also the protrusions 150. A plurality of protrusions 150 are formed below each stopper 140 to ensure that, if acceleration drives the mass 133 toward the stoppers 140 at an angle such that the protrusions 150 strike the stopper 140 in only one corner of the sensor, the impact force will not be concentrated on just one protrusion 150, which might damage the sensor.

The first joining layer 132 in FIG. 7 has the same plan geometry as the mass attachment section 131 in FIG. 6, and the second joining layer 112 has the same plan geometry as the peripheral attachment section 111. Below the beams 120 and stoppers 140, the joining layer 102 is removed during the fabrication process, except for the protrusions 150.

The second layer 103, shown in FIG. 8, which includes the peripheral frame 113 and mass 133, is a silicon layer with a preferred thickness of 200-400 μm. The shape of the mass 133, with large outer lobes and a smaller central part, is designed to maximize its total size and hence its total inertial mass, while also maximizing the length of the beams; both of these factors enhance the sensitivity of the acceleration sensor. The thickness of the mass 133 is preferably 8-15 μm less than the thickness of the frame 113. This thickness difference, best seen in FIG. 3, corresponds to the maximum distance through which the mass 133 can move from its rest position in the direction away from the stoppers 140.

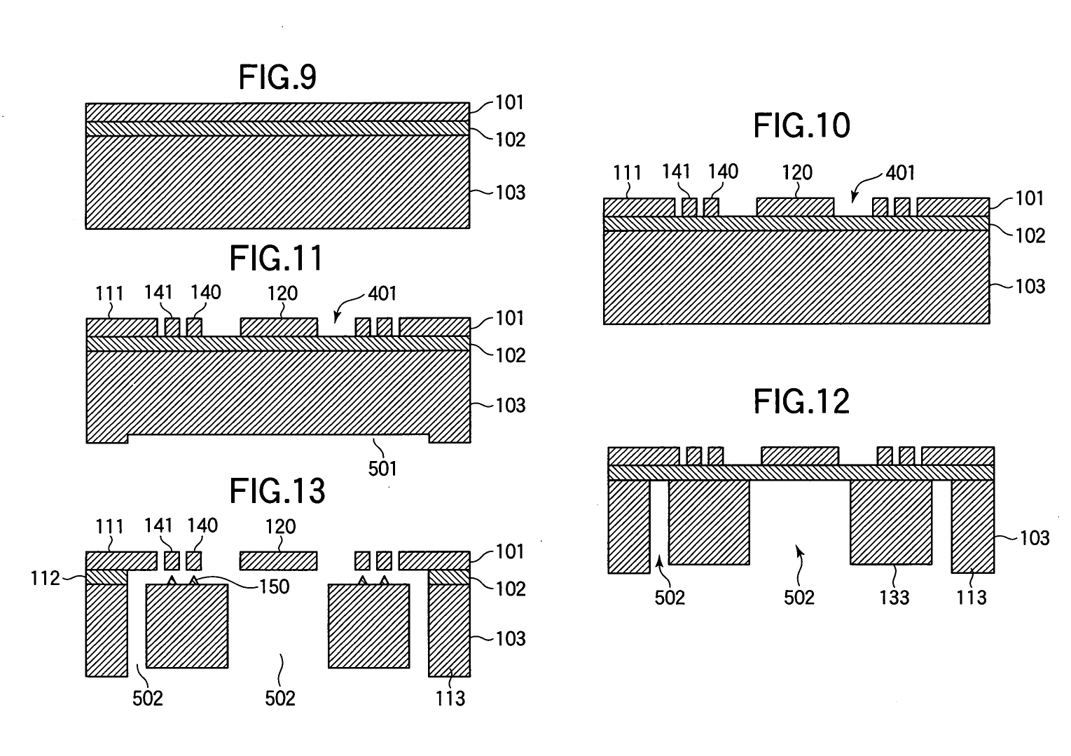

A fabrication process for this acceleration sensor will now be described with reference to FIGS. 9 to 13, which correspond to sections through line AA′ in FIG. 1.

The fabrication process starts from a silicon-on-insulator (SOI) wafer substrate having a first layer 101, a joining layer 102, and a second layer 103 as shown in FIG. 9. The joining layer 102 may be a so-called buried oxide layer. Although only one acceleration sensor is shown in the drawings, normally many acceleration sensors are fabricated simultaneously in the same wafer.

First, standard microelectronic semiconductor fabrication methods are used to form piezoresistive elements (not shown) in the part of the first layer 101 that will become the beams 120. In addition, the first layer 101 is anisotropically etched to form the trenches 401 shown in FIG. 6 that define the peripheral attachment section 111, beams 120, mass attachment section 131, and stoppers 140, and to form a plurality of holes 141 in each stopper 140. The result is illustrated in FIG. 10.

Next, the underside of the second layer 103 of the wafer is etched to a depth of 8-15 μm in the region that will become the mass 133, as shown in FIG. 11.

The underside of the second layer 103 is then further etched by an anisotropic etching process to form trenches 502 as shown in FIG. 12 that separate the mass 133 from the frame 113 and that separate the lobes of the mass 133 from each other. This etching process removes all parts of the second layer 103 from beneath the beams 120 and from a square annular ring just inside the frame 113; the etching process ends at the joining layer 102, which is not etched.

Finally, a wet etching process is performed by immersing the wafer in an etching fluid that etches the silicon oxide of the joining layer 102 but does not etch the silicon of the first and second layers 101 and 103 (more precisely, the etching fluid etches silicon oxide much more rapidly than silicon). The etching fluid easily reaches the part of the joining layer 102 exposed by the trenches 401 and 502 formed in the preceding steps and removes all of the joining layer 102 from the area beneath the beams 120 and the area between the frame 113 and mass 133. As wet etching is isotropic, the etching process also proceeds laterally from these trenches 140, 152 into the spaces between the stoppers 140 and mass 133. Additional etching fluid reaches this space through the holes 141 in the stoppers 140, and by etching isotropically from the ends of the holes 141, excavates a cavity beneath each hole. The cavity is wider at the top (near the hole) than at the bottom (on the surface of the mass 133). As these cavities grow, they shape the protrusions 150. If the etching conditions are properly selected, protrusions 150 of the desired height will be left on the surfaces of the mass 133 beneath the stoppers 140, as shown in FIG. 13. In experiments by the inventor, appropriate protrusions 150 were formed with a total wet etching time of about seventy minutes.

After wet etching, the completed acceleration sensor is cleaned to rinse away the etching fluid, and then dried. The protrusions 150 prevent the mass 133 from sticking to the stoppers 140 during the drying process, so the dried acceleration sensor can immediately be diced from the wafer and mounted in an appropriate package.

The wet etching step may be performed as a single continuous process, or as a series of short etch-rinse cycles. The latter strategy promotes etching by removing the etched silicon oxide material at the end of each cycle and replacing the spent etching fluid, which has already reacted with the silicon oxide, with fresh etching fluid. Etching may be further promoted by immersing the wafer in a surfactant solution before each etching cycle, to reduce the surface tension of the etching fluid and rinsing fluid and enable etching to proceed efficiently even in the narrow space between the mass 133 and stoppers 140.

As the wet etching process forms protrusions 150 not in the areas 152 directly beneath the holes 141 but at locations between these areas, if acceleration moves the mass 133 toward the stoppers 140 during operation of the acceleration sensor, the protrusions 150 will strike the surface of the stoppers 140, as desired, instead of entering the holes 141.

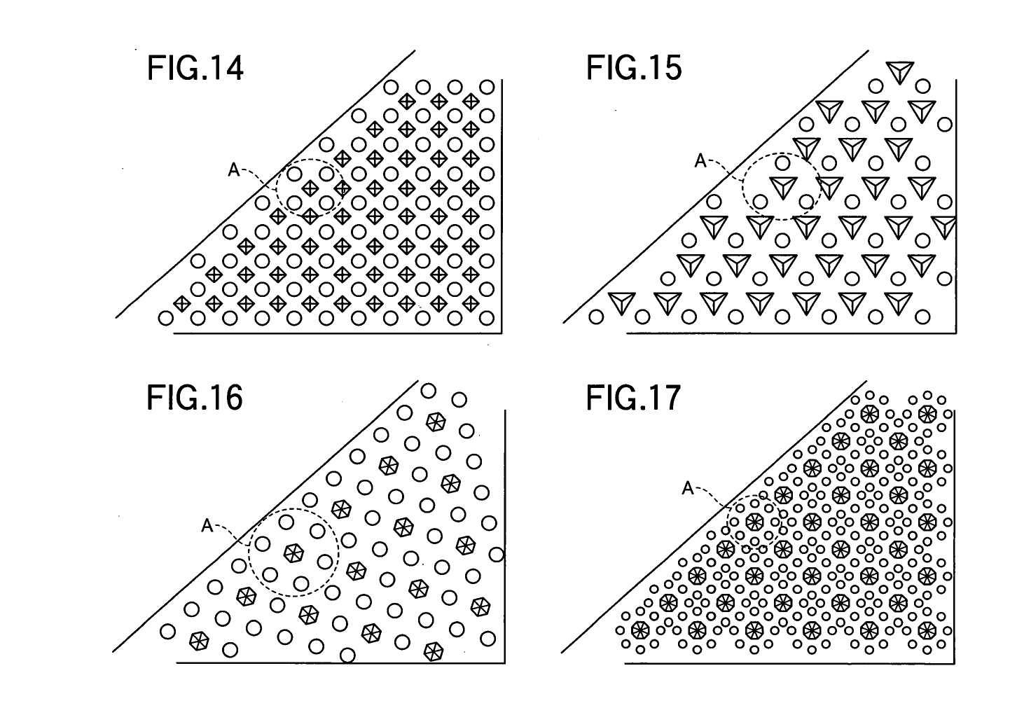

The number of holes 141 and protrusions 150 per stopper 140 is not limited to the numbers shown in FIGS. 1, 2, 5, and 6; a larger number may be formed, as illustrated in FIG. 14, for example. The preferred diameter of the holes 141 is 3-4 μm, and the preferred spacing between the edges of adjacent holes 141 is 4.5-5.5 μm. The center-to-center spacing of the holes 141 is then approximately 8.5 μm.

In the design stage, the holes 141 can be laid out by defining two holes on an imaginary reference line, then translating the line so that one hole occupies the location of the other hole, rotating the line by ninety degrees to define a new hole, and repeating this process until all the necessary holes have been defined. Alternatively, a unit cell A of four holes 141 surrounding one protrusion 150 can be defined; then the unit cell can be stepped horizontally and vertically to define further holes 141.

The layout is not limited to the square cell A shown in FIG. 14. A triangular cell A with three holes 141 surrounding one protrusion 150 can be used, as shown in FIG. 15, or a hexagonal cell with six holes 141 surrounding one protrusion 150 can be used, as shown in FIG. 16. The resulting protrusions 150 will then have a triangular pyramidal shape or a hexagonal pyramidal shape, as shown in FIGS. 15 and 16. Increasing the number of holes around each protrusion 150 increases the etching speed, so to shorten the etching time, the number of holes 141 may be increased still further. FIG. 17 shows a unit cell A with eight holes 141, for example, which produces protrusions 150 with an octagonal pyramidal shape.

Increasing the number of holes 141 also weakens the stoppers 140, however, and therefore reduces the ability of the sensor to withstand shock. The number of holes 141 per protrusion 150 and hence the shape of the protrusions 150 should be selected by balancing requirements for quick etching against requirements for a robust acceleration sensor. The square pyramidal shape shown in FIGS. 5 and 14 is thought to represent an appropriate compromise.

It not necessary to tile the entire surface of a stopper 140 with unit cells A as in FIGS. 14 to 17. A few unit cells may be placed at selected locations in the stopper 140. This provides another way to achieve an appropriate balance between robustness and short etching time.

During operation, as noted above, the protrusions 150 reduce the distance through which the mass section 130 can travel in the direction perpendicular to the surfaces of the stoppers 140. This has the desirable effect of reducing the risk of damage to the acceleration sensor if strong acceleration drives the mass 133 forcefully against the stoppers 140.

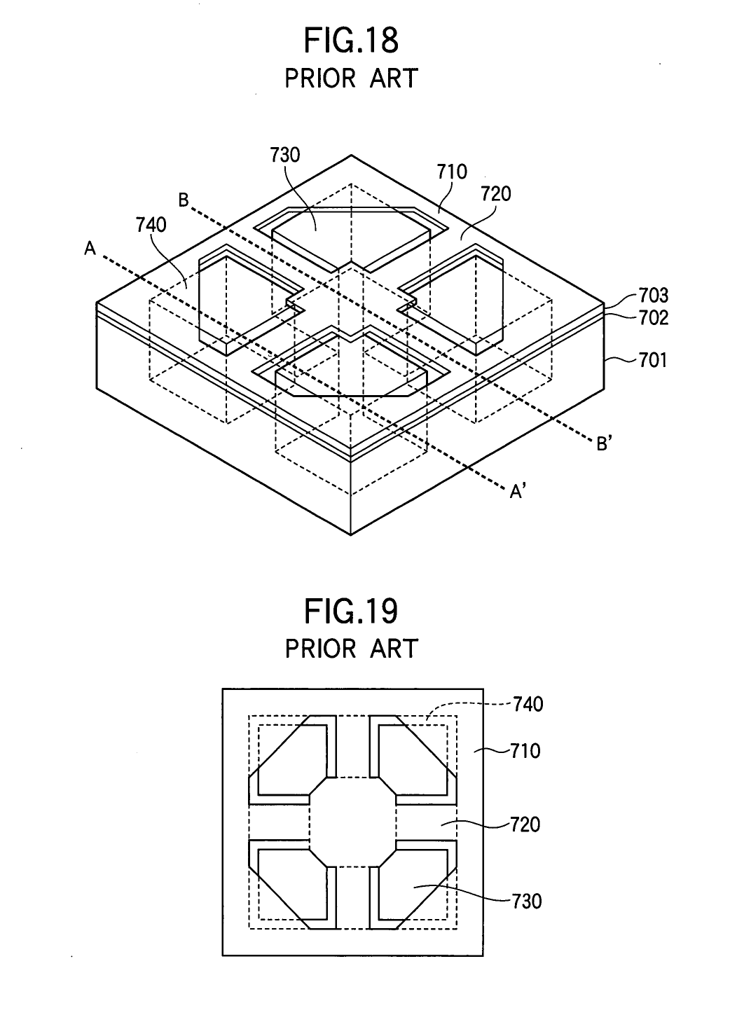

For comparison, FIG. 18 shows a conventional acceleration sensor of the type described in JP 2004-198243, comprising a first layer 701, joining layer 702, second layer 703, peripheral section 710, beams 720, mass section 730, and stoppers 740 similar to the corresponding elements in FIG. 1, except that the stoppers 740 lack holes. FIG. 19 shows a plan view of the first layer 701.

The fabrication process for this conventional acceleration sensor is virtually identical to the fabrication process for the inventive acceleration sensor described above, except that because of the lack of holes in the stoppers 740, the wet etching step takes longer and does not leave protrusions.

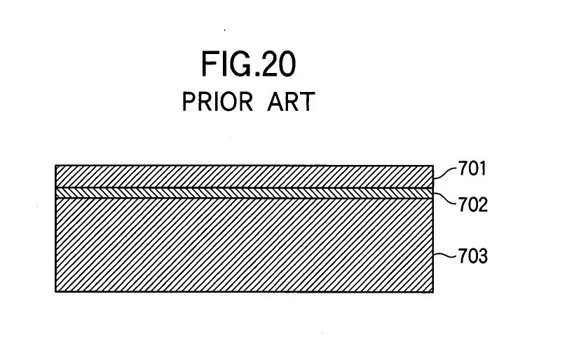

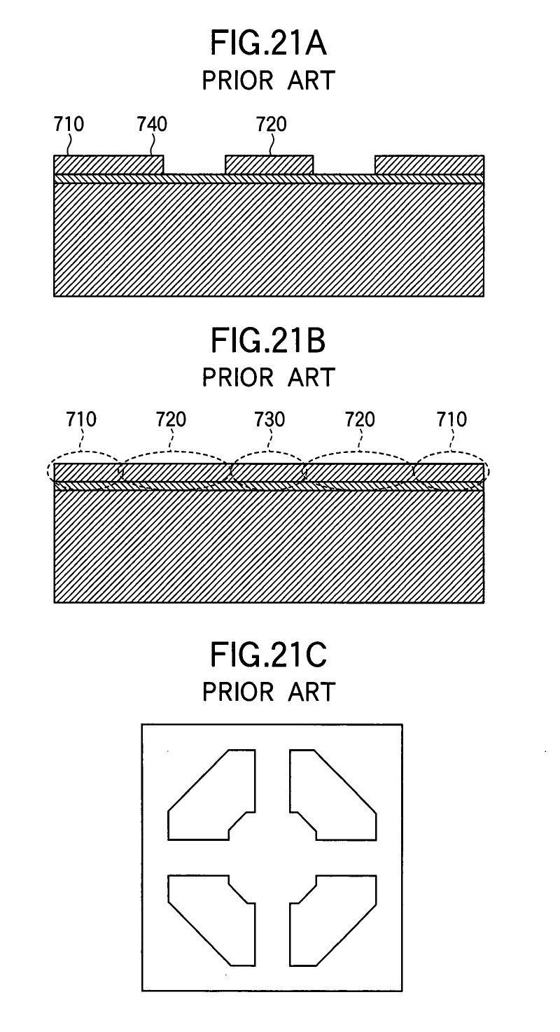

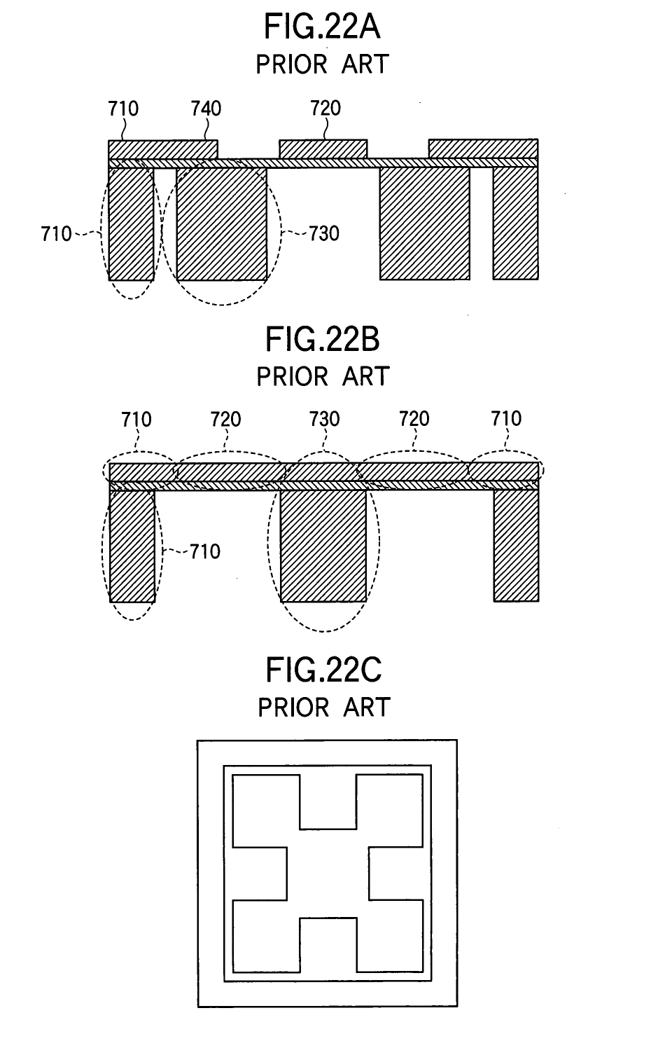

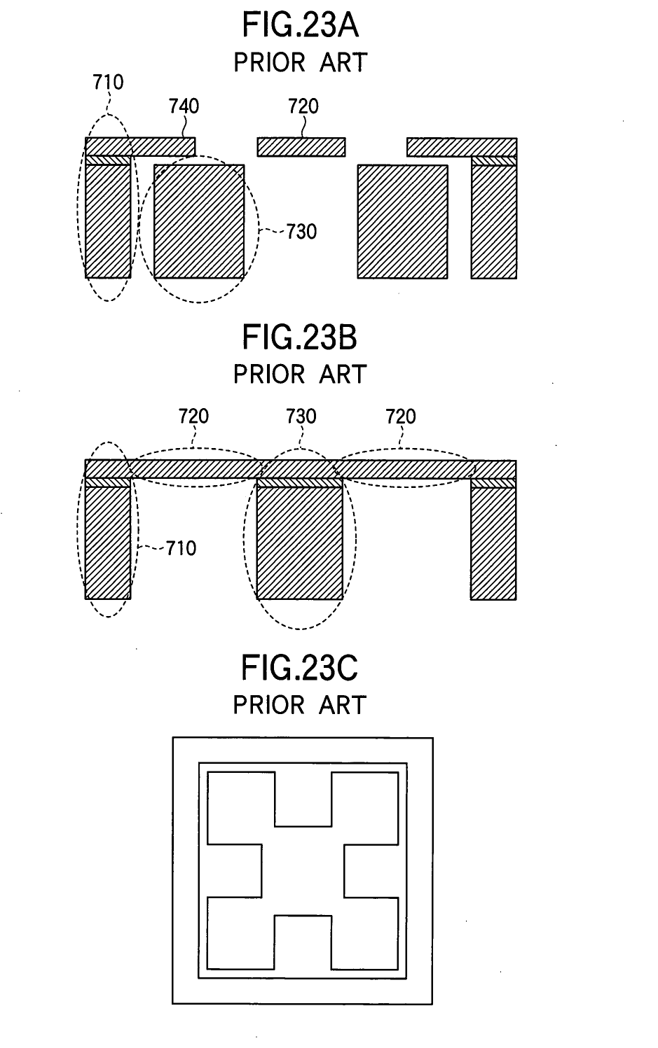

The conventional fabrication process begins from an SOI wafer substrate as illustrated in FIG. 20. The first layer 701 is anisotropically etched to define the upper parts of the peripheral section 710 and mass section 730, the beams 720, and the stoppers 740 as shown in FIG. 21A (a sectional view through line AA′ in FIG. 18), FIG. 21B (a sectional view through line BB′ in FIG. 18), and FIG. 21C (a top plan view of the first layer 701). Next the second layer 703 is anisotropically etched to define the lower parts of the peripheral section 710 and mass section 730, as shown in sectional views in FIGS. 22A (another view through line AA′) and 22B (another view through line BB′) and in a bottom plan view in FIG. 22C. Finally, a wet etching process is performed to remove the joining layer 702 from the undersides of the beams 720 and stoppers 740, as shown in sectional views in FIGS. 23A (again through line AA′) and 23B (again through line BB′) and a plan view of the resulting patterned joining layer 702 in FIG. 23C.

The total wet etching time in the conventional fabrication process, when performed under the same wet etching conditions as in the above embodiment, is about eighty minutes. The present invention thus reduces the wet etching time by about ten to thirteen percent. Moreover, when the conventional acceleration sensor is dried after wet etching and cleaning, the mass 730 sometimes sticks to the stoppers 740, as noted above, and further time is required to deal with this problem. The invention thus leads to a quicker manufacturing process, as well as a more robust and more sensitive sensor.

The foregoing represents one preferred embodiment of the invention. Those skilled in the art will recognize that many other embodiments and variations are possible within the scope of the invention, which is defined in the appended claims.

What is claimed is:

1. An acceleration sensor comprising:
a patterned layer including a mass attachment section, a peripheral attachment section surrounding and spaced apart from the mass attachment section, at least one beam flexibly linking the mass attachment section to the peripheral attachment section, and at least one stopper connected to the peripheral attachment section and spaced apart from the mass attachment section and the beam;
a mass spaced apart from the stopper, having a surface facing the stopper;
a first joining layer joining the mass to the attachment section;
a frame surrounding and spaced apart from the mass;
a second joining layer joining the frame to the peripheral attachment section; and
at least one protrusion protruding from said surface of the mass toward the stopper, the protrusion being spaced apart from the stopper when acceleration is absent.

2. The acceleration sensor of claim 1, wherein the acceleration sensor has more than one said protrusion, the more than one said protrusion being arranged in a regular two-dimensional array extending over substantially all parts of said surface of the mass.

3. The acceleration sensor of claim 1, wherein each said protrusion has a square pyramidal shape.

4. The acceleration sensor of claim 1, wherein each said protrusion has a triangular pyramidal shape.

5. The acceleration sensor of claim 1, wherein each said protrusion has a hexagonal pyramidal shape.

6. The acceleration sensor of claim 1, wherein each said protrusion has an octagonal pyramidal shape.

7. The acceleration sensor of claim 1, wherein the first joining layer, the second joining layer, and the protrusion are made of mutually identical materials.

8. The acceleration sensor of claim 7, wherein the stopper has a plurality of holes facing respective areas on said surface of the mass, each said protrusion being disposed between at least two of said areas.

9. The acceleration sensor of claim 8, wherein each said protrusion has a polygonal shape with sides facing respective ones of said areas.

10. The acceleration sensor of claim 8, wherein the holes are arranged in a regular two-dimensional array extending over substantially all parts of the stopper that face the mass.

11. The acceleration sensor of claim 8, wherein the holes have diameters of at least three micrometers.

12. The acceleration sensor of claim 11, wherein the holes have diameters of at most four micrometers.

13. The acceleration sensor of claim 8, wherein mutually adjacent ones of the holes have centers mutually separated by a distance of at least 7.5 micrometers.

14. The acceleration sensor of claim 13, wherein mutually adjacent ones of the holes have centers mutually separated by a distance of at most 9.5 micrometers.

15. The acceleration sensor of claim 1, wherein the first joining layer and the second joining layer have a thickness of at least one micrometer.

16. The acceleration sensor of claim 15, wherein the first joining layer and the second joining layer have a thickness of at most three micrometers.
